(19) United States
(12) Patent Application Publication
(10) Pub. No.: US 2014/0128498 A1
(43) Pub. Date: May 8, 2014

(54) TIRE MEMBER AND METHOD FOR MANUFACTURING THE SAME

(71) Applicant: Toyo Tire & Rubber Co., Ltd., Osaka (JP)

(72) Inventor: Ikuo Ihara, Osaka-shi (JP)

(73) Assignee: TOYO TIRE & RUBBER CO., LTD., Osaka (JP)

(21) Appl. No.: 13/959,426

(22) Filed: Aug. 5, 2013

(30) Foreign Application Priority Data
Nov. 7, 2012 (JP) 2012-245622

(51) Int. Cl. C08L 23/22; C08L 7/00; C08K 13/02

(52) U.S. Cl. CPC C08L 23/22; C08K 13/02; C08L 7/00
USPC 523/156; 524/157

(57) ABSTRACT

A method for manufacturing a tire member, that improves various performances such as abrasion resistance, tear strength, fatigue resistance and the like of the tire member in good balance is provided. The method includes a step (A) for mixing at least a rubber component, a filler and a thiosulfuric acid compound containing an amino group, and a step (B) for mixing the mixture obtained by the step (A), a sulfur component, and a vulcanization accelerator, wherein the thiosulfuric acid compound containing an amino group is added in an amount of 0.2 parts by mass or more to 100 parts by mass of the rubber component in the step (A), and a temperature of the mixture during mixing is maintained within a range of from 145 to 170° C. for 20 seconds or more in the step (A).

### BACKGROUND OF THE INVENTION

1. Field of the Invention

The present invention relates to a method for manufacturing a tire member including a step of adding a thiosulfuric acid containing an amino group to a rubber composition, and a tire member obtained by the manufacturing method.

2. Background Art

For example, Patent Documents 1 to 5 disclose that reduction in heat generation property of a rubber composition and improvement in viscoelasticity thereof are possible by adding a thiosulfuric acid containing an amino group to a vulcanized rubber composition.

However, various characteristics are further required in a tire. For example, improvement in abrasion resistance and tear strength (cut resistance) is required in a tread part, and improvement in tear strength and fatigue resistance is required in a side part.

It is known that abrasion resistance and tear strength of a tire can be improved by, for example, using carbon black having smaller particle diameter. However, use of such carbon black gives rise to a problem of deterioration in processability. A method of adding a resin for the purpose of improving tear strength is known. However, the addition of a resin may decrease fracture characteristic.

The present inventors have found that abrasion resistance, tear strength, fatigue resistance and the like of a tire member can be improved by mixing an organic thiosulfuric acid compound containing an amino group or its salt with a rubber composition. However, the effect by the mixing is variable, and it is the current situation that the means for maximizing the effect by the addition of the thiosulfuric acid compound is still seeking.

Patent Document 1: JP-A-2012-12458

Patent Document 2: JP-A-2012-12457

Patent Document 3: JP-A-2012-107232

Patent Document 4: JP-A-2012-116813

Patent Document 5: JP-A-2012-117008

### SUMMARY OF THE INVENTION

The present invention has been made in view of the above circumstances, and has an object to provide a manufacturing method for surely and markedly improving various performances such as abrasion resistance, tear strength and fatigue resistance of a tire member by adding a thiosulfuric acid compound containing an amino group, and a tire member obtained by the manufacturing method.

A method for manufacturing a tire member according to the present invention contains a step (A) for mixing at least a rubber component, a filler and a thiosulfuric acid compound containing an amino group, and a step (B) for mixing the mixture obtained by the step (A), a sulfur component and a vulcanization accelerator, wherein the thiosulfuric acid compound containing an amino group is added in an amount of 0.2 parts by mass or more to 100 parts by mass of the rubber component in the step (A), and a temperature of the mixture during mixing in the step (A) is maintained in a range of from 145 to 170° C. for 20 seconds or more in the step (A).

In the manufacturing method of the present invention, the temperature of the mixture during mixing in the step (A) is preferably maintained in a range of x±5° C. (x=150 to 165° C.) for 20 seconds or more.

The thiosulfuric acid compound containing an amino group is preferably at least one selected from the group consisting of thiosulfuric acid compounds represented by any one of the following formulae (1) to (3) and their salts.

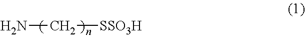

wherein n is an integer of from 2 to 9.

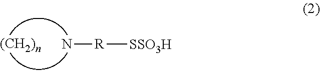

wherein R represents an alkanediyl group having from 3 to 12 carbon atoms, and n is an integer of from 2 to 5.

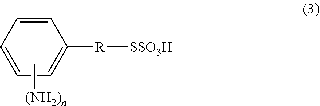

wherein R represents an alkanediyl group having from 1 to 6 carbon atoms, and n is an integer of from 1 to 2.

The mixing in the step (A) is conducted by a mixing apparatus equipped with a stirring rotor, a jacket through which a heating/cooling medium flows, and a pressure ram, and at least one of a rotation speed of the stirring rotor of the mixing apparatus, a temperature of the heating/cooling medium and a ram pressure can be controlled to maintain a temperature of the mixture within the above temperature range.

The manufacturing method of the present invention can be used to produce a tread member or a sidewall member of a tire.

The tire member of the present invention is obtained by the manufacturing method of the present invention.

The tire of the present invention contains the tire member of the present invention.

According to the present invention, a tire member having improved abrasion resistance, tear strength, fatigue resistance and the like in good balance is obtained by restricting temperature and time when mixing the thiosulfuric acid compound containing an amino group as described above.

### DETAILED DESCRIPTION OF THE INVENTION

The embodiment for carrying out the present invention is described in detail below.

The method for manufacturing a tire member according to the present invention contains at least the above-described step (A) and step (B), and at least a rubber component, a filler and a thiosulfuric acid compound containing an amino group are mixed in the step (A).

Examples of the rubber component that can be used in the present invention include various natural rubbers (NR), various polyisoprene rubbers (IR), various styrene-butadiene rubbers (SBR), and various polybutadiene rubbers (BR). Those rubbers may be used in any one kind alone or as mixtures of two or more kinds. Various natural rubbers and various polybutadiene rubbers are preferably used. Modified diene rubbers having introduced therein an amino group, an alkoxysilane group, a hydroxy group, and epoxy group, a carboxy group, a cyano group, a halogen and the like can be used as the rubbers, as may be necessary.

Examples of the filler include carbon black, silica, talc, clay, aluminum hydroxide and titanium oxide that are generally used in a rubber field. In general, carbon black and silica are preferably used.

The amount of the filler added is not particularly limited, and is appropriately adjusted depending on purpose of use and the like of the tire member. When only carbon black is used, the amount thereof is preferably a range of from 30 to 80 parts by mass per 100 parts by mass of the rubber component. When silica is added, the amount thereof is preferably a range of from 10 to 120 parts by mass per 100 parts by mass of the rubber component. Furthermore, when silica is added, carbon black is preferably added in an amount of from 5 to 50 parts by mass per 100 parts by mass of the rubber component. The ratio of silica/carbon black is particularly preferably from 0.7/1 to 1/0.1.

When silica is used as the filler, a silane coupling agent is preferably concurrently used. The kind of the silane coupling agent is not particularly limited, and silane coupling agents generally used in a rubber composition for a tire can be used. Examples of the silane coupling agent used include sulfide silane and mercaptosilane. The content of the silane coupling agent is preferably from 5 to 15 mass % based on silica.

The thiosulfuric acid compound represented by any one of the above formulae (1) to (3) or any one of salts thereof can be preferably used as the thiosulfuric acid compound containing an amino group used in the present invention. Those can be used as one kind alone or as mixtures of two or more kinds thereof. Examples of the salt include an alkali metal salt such as lithium salt, sodium salt, potassium salt or cesium salt; a transition metal salt such as cobalt salt or copper salt; a typical metal salt such as zinc salt; and a substituted or unsubstituted ammonium salt such as ammonium salt or trimethylammonium salt. Of those salts, a metal salt of lithium, sodium, potassium, cesium, cobalt, copper or zinc is preferred, and above all, lithium salt, sodium salt or potassium salt is preferred. When the thiosulfuric acid compound and its salt are used as a mixture thereof in the present invention, the mixture can be a mixture obtained by, for example, a method of mixing the thiosulfuric acid compound and its salt, a method of forming a part of the thiosulfuric acid compound into a metal salt using an alkali metal, or a method of neutralizing a part of a metal salt of the thiosulfuric acid compound using proton acid. The term “at least one of a thiosulfuric acid compound represented by any one of the formulae (1) to (3) or its salt” is hereinafter sometimes referred to as “thiosulfuric acid compound and/or its salt”.

Preferred examples of the compound represented by the formula (1) include S-(3-aminopropyl)thiosulfuric acid, S-(3-aminobutyl)thiosulfuric acid, S-(3-aminopentyl)thiosulfuric acid, and S-(3-aminohexyl)thiosulfuric acid.

The compound represented by the formula (1) can be produced by any conventional method. A salt of S-(3-aminopropyl)thiosulfuric acid can be produced by, for example, a method of reacting 3-halopropylamine and sodium thiosulfate, or a method of reacting phthalimide potassium salt and 1,3-dihalopropane, reacting the compound thus obtained and sodium thiosulfate, and then hydrolyzing the compound thus obtained. S-(3-aminopropyl)thiosulfuric acid can be produced by neutralizing a salt of S-(3-aminopropyl)thiosulfuric acid with proton acid. S-(3-aminopropyl)thiosulfuric acid and/or its salt thus produced can be isolated by an operation such as concentration or crystallization, and the S-(3-aminopropyl)thiosulfuric acid and/or its salt isolated generally contain from about 0.1 to 5% of water.

Examples of the compound represented by the formula (2) include S-3-(piperidin-1-yl)propylthiosulfuric acid, S-4-(piperidin-1-yl)butylthiosulfuric acid, S-5-(piperidin-1-yl)pentylthiosulfuric acid, S-6-(piperidin-1-yl)hexylthiosulfuric acid, S-7-(piperidin-1-yl)heptylthiosulfuric acid, S-8-(piperidin-1-yl)octylthiosulfuric acid, S-10-(piperidin-1-yl)decylthiosulfuric acid, S-12-(piperidin-1-yl)dodecylthiosulfuric acid, S-3-(pyrrolidin-1-yl)propylthiosulfuric acid, S-4-(pyrrolidin-1-yl)butylthiosulfuric acid, S-5-(pyrrolidin-1-yl)pentylthiosulfuric acid, S-6-(pyrrolidin-1-yl)hexylthiosulfuric acid, S-7-(pyrrolidin-1-yl)heptylthiosulfuric acid, S-8-(pyrrolidin-1-yl)octylthiosulfuric acid, S-10-(pyrrolidin-1-yl)decylthiosulfuric acid, and S-12-(pyrrolidin-1-yl)dodecylthiosulfuric acid. Of those, S-3-(piperidin-1-yl)propylthiosulfuric acid, sodium S-3-(piperidin-1-yl)propylthiosulfate, S-6-(piperidin-1-yl)hexylthiosulfuric acid or sodium S-6-(piperidin-1-yl)hexylthiosulfate is preferred, and sodium S-3-(piperidin-1-yl)propylthiosulfate is particularly preferred.

The compound represented by the formula (2) can be produced by, for example, the following reaction formula.

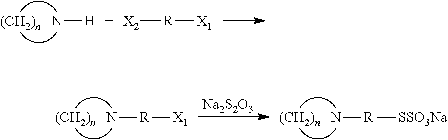

In the above reaction formula, R and n are the same as defined in the formula (2), and X₁ and X₂ each independently represent chlorine atom, bromine atom or iodine atom.

According to the production method, a sodium salt is generally obtained, but a desired compound can be produced by conducting cation exchange as necessary. The compound obtained generally contains from about 0.1 to 5% by mass of water.

Examples of the compound represented by the formula (3) include S-(4-aminophenyl)methylthiosulfuric acid, S-[2-(4-aminophenyl)ethyl]thiosulfuric acid, S-[3-(4-aminophenyl)propyl]thiosulfuric acid, S-[4-(4-aminophenyl)butyl]thiosulfuric acid, S-[5-(4-aminophenyl)pentyl]thiosulfuric acid, S-[6-(4-aminophenyl)hexyl]thiosulfuric acid, S-[2-(3-aminophenyl)methyl]thiosulfuric acid, S-[2-(3-aminophenyl)ethyl]thiosulfuric acid, S-[3-(3-aminophenyl)propyl]thiosulfuric acid, S-[4-(3-aminophenyl)butyl]thiosulfuric acid, S-[5-(3-aminophenyl)pentyl]thiosulfuric acid, S-[6-(3-aminophenyl)hexyl]thiosulfuric acid, S-(2-aminophenyl)methylthiosulfuric acid, S-[2-(2-aminophenyl)ethyl]thiosulfuric acid, S-[3-(2-aminophenyl)propyl]thiosulfuric acid, S-[4-(2-aminophenyl)butyl]thiosulfuric acid, S-[5-(2-aminophenyl)pentyl]thiosulfuric acid, S-[6-(2-aminophenyl)hexyl]thiosulfuric acid, S-(3,5-diaminophenyl)methylthiosulfuric acid, S-(3,4-diaminophenyl)methylthiosulfuric acid, S-[2-(3,5-diaminophenyl)ethyl]thiosulfuric acid, and S-[2-(3,4-diaminophenyl)ethyl]thiosulfuric acid. Of those, S-[2-(4-aminophenyl)ethyl]thiosulfuric acid and sodium S-[2-(4-aminophenyl)ethyl]thiosulfate are preferred, and sodium S-[2-(4-aminophenyl)ethyl]thiosulfate is particularly preferred.

The compound represented by the formula (3) can be produced by, for example, the following reaction formula.

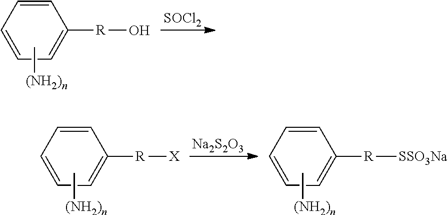

In the above reaction formula, R and n are the same as defined in the formula (3), and X represents chlorine atom, bromine atom or iodine atom.

According to the production method, a sodium salt is generally obtained, but a desired compound can be produced by conducting cation exchange as necessary. The compound obtained generally contains from about 0.1 to 5% by mass of water.

The amount of the thiosulfuric acid compound and/or its salt added in the step (A) of the manufacturing method of the present invention is preferably 0.2 parts by mass or more (that is, 0.2 phr or more), and more preferably from 0.2 to 5 parts by mass, per 100 parts by mass of the rubber component. Where the amount is less than 0.2 parts by mass, improvement in the desired properties such as abrasion resistance, tear strength and fatigue resistance may be insufficient.

In the step (A), zinc oxide, stearic acid, an age resister, an oil, and other components and additives generally used in manufacturing a tire rubber member can be added, other than the above-described rubber component, filler and thiosulfuric acid compound and/or its salt. The amount of those added is not limited, and is appropriately adjusted depending on, for example, use purpose of a tire member. In general, the amount of zinc oxide used is preferably a range of from 1 to 15 parts by mass, and more preferably a range of from 3 to 8 parts by mass, per 100 parts by mass of the rubber component. The amount of stearic acid used is preferably a range of from 0.5 to 10 parts by mass, and more preferably a range of from 1 to 5 parts by mass, per 100 parts by mass of the rubber component.

The mixing of the rubber component, the filler, and the thiosulfuric acid compound and/or its salt in the step (A) is an operation generally called kneading, and can be conducted using the conventional mixing apparatus equipped with at least a stirring rotor, a jacket through which a heating/cooling medium flows, and a pressure ram, such as Banbury mixer. The heating/cooling medium is heated as necessary so as to reach a desired temperature, flows in the jacket, and heats or cools the mixture by heat transfer of a wall surface of a mixing vessel. Water is generally used as the heating/cooling medium. The pressure ram moves up and down in a cylinder and adjusts a pressure in the mixing apparatus. The mixing apparatus is preferably further equipped with a temperature sensor detecting a temperature of a mixture in the equipment, and a control part controlling the number of revolutions of a rotor.

Kneading of a rubber generally involves generation of heat. Therefore, if any control is not conducted, a temperature of a mixture during mixing is rapidly increased. In the manufacturing method of the present invention, mixing conditions and the like are adjusted such that the temperature of the mixture during mixing in the step (A) is maintained in a range of from 145 to 170° C. for 20 seconds or more. Specifically, the temperature can be maintained in the above range by controlling at least one of the rotation speed of the mixing apparatus, the temperature of the heating/cooling medium, and the ram pressure. Temperature control of the mixture becomes more easy and secure by automatically controlling the rotation speed, and the like by PID (Proportional Integral Differential) control.

Where the time maintained in the above temperature range is less than 20 seconds, the improvement effect of abrasion resistance, tear strength and fatigue resistance is insufficient. Improvement effect of each physical property is increased with mixing the thiosulfuric acid compound and/or its salt at higher temperature. On the other hand, when the rubber is exposed to high temperature, the decrease in molecular weight and gelation occur, and this results in deterioration of abrasion resistance and deterioration of fatigue resistance. Therefore, it is considered that by conducting the mixing in the above temperature range and for the above period of time, the effect by the addition of the thiosulfuric acid compound and/or its salt is increased while suppressing the decrease in properties of a rubber due to high temperature mixing.

The case that the time maintained in the above temperature range is less than 20 seconds simulates, for example, a case that temperature increase is mild and a temperature when discharging is lower than 145° C., a case that even though reached 145° C., the time from this to the discharge is less than 20 seconds, or a case that a temperature is rapidly increased and the mixture passes the temperature range within 20 seconds.

The upper limit of the time maintained in the above temperature range is preferably 120 seconds or less, and more preferably 60 seconds or less. The mixing at high temperature for a long period of time causes the decrease in a molecular weight of a rubber and gelation, and this may lead to the decrease in abrasion resistance and fatigue resistance. Furthermore, the mixing leads to deterioration of productivity by the increase in mixing time, and the increase in cost of energy used in the mixing. Therefore, the cost effectiveness is decreased.

Preferably, the control of the rotation speed of the rotor, and the like is severely conducted to maintain the temperature of the mixture during mixing in a range of x±5° C. (x=150 to 165° C.) for 20 seconds or more. That is, when a temperature fallen within a range of from 150 to 165° C. is defined as reference temperature x, the temperature is controlled such that the minimum temperature is (x-5)° C. or higher and the maximum temperature is (x+5)° C. or lower, such as a range of from 145 to 155° C. or a range of from 160 to 170° C. Thus, when the mixture is maintained for a certain period of time while keeping the decreased temperature variation, the action by the thiosulfuric acid compound and/or its salt is further increased, and the improvement effect of each property becomes more remarkable. Particularly preferably, the mixture is maintained at a temperature in a range of 160° C.±5° C., that is, a range of from 155 to 165° C., for a period of from 20 to 120 seconds.

The maximum temperature of the mixture through the whole step (A) is preferably 170° C. or lower. Where the temperature of the mixture exceeds 170° C., physical properties may be deteriorated due to deterioration of a rubber. The mixing time as the whole step (A) is not particularly limited, and is generally from 1 to 10 minutes.

The step (B) of the present invention, that is, a step for mixing the mixture obtained in the step (A), a sulfur component and a vulcanization accelerator, is described below.

Examples of the sulfur component used include powdered sulfur, precipitated sulfur, colloidal sulfur, insoluble sulfur and high dispersion sulfur. In general, powdered sulfur is preferred, and in the case of using in a tire member containing a large amount of sulfur, such as a member for a belt, insoluble sulfur is preferred. The sulfur component used herein does not include the thiosulfuric acid compounds represented by any one of the formulae (1) to (3) and their salts. The amount of the sulfur component used is preferably a range of from 0.3 to 5 parts by mass, and more preferably a range of from 0.5 to 3 parts by mass, per 100 parts by mass of the rubber component.

The vulcanization accelerator is not particularly limited, and examples thereof include a thiazole vulcanization accelerator, a sulfenamide vulcanization accelerator, and a guanidine vulcanization accelerator.

The ratio between the sulfur component and the vulcanization accelerator is not particularly limited, but is preferably a range of sulfur component/vulcanization accelerator=2/1 to 1/2 in mass ratio. A so-called EV vulcanization in which the ratio of sulfur/vulcanization accelerator is 1 or less, which is a method for improving heat resistance of a rubber component mainly containing natural rubber, is preferably used in the present invention in uses in which the improvement of heat resistance is particularly required.

The mixing of the kneaded material obtained in the step (A), the sulfur component and the vulcanization accelerator in the step (B) is an operation generally called kneading, and can be conducted according to the conventional methods using a mixing apparatus such as an open roll or Banbury mixer.

The kneading time is preferably from 1 to 10 minutes, and more preferably from 2 to 8 minutes. When the kneading time is 1 minute or more, dispersibility of the sulfur component and the vulcanization accelerator in the rubber composition tends to be increased, and when the kneading time is 10 minutes or less, deterioration of the rubber component tends to be suppressed. Those are preferred in that viscoelasticity characteristic of the vulcanized rubber finally obtained is improved.

The mixture obtained as above is subjected to a heat treatment generally called vulcanization. The heat treatment is conducted under ordinary pressures or under pressure, and the treatment temperature is generally from about 120 to 180° C.

The tire member of the present invention obtained as above has improved abrasion resistance, tear strength, fatigue resistance and the like in good balance, and therefore can be preferably used as a tread member such as a base tread or a cap tread, of various tires, and a sidewall member.

Specifically, a tire member is obtained by extrusion molding the mixture into a predetermined cross-sectional shape corresponding to the intended tire member such as a tread member or a sidewall member, or forming a ribbon-like rubber strip from the mixture and spirally winding the strip on a drum, thereby forming the strip into a cross-sectional shape corresponding to the intended tire member. The tire member is vulcanization molded according to the conventional method together with other tire member constituting a tire, such as an inner liner, a carcass, a belt, a bead core or a bead filler, whereby the tire of the invention can be obtained.

### EXAMPLES

Working examples of the present invention are described below, but the present invention is not limited to those examples. Unless otherwise indicated, addition proportion described hereinafter is mass basis (parts by mass, % by mass and the like). Production method of compounds A and B used in the following examples and comparative examples is as follows.

### Production of Compound A (sodium S-(3-aminopropyl)thiosulfate)

A reaction vessel was purged with nitrogen. 25 g (0.11 mol) of 3-bromopropylamine bromate, 28.42 g (0.11 mol) of sodium thiosulfate pentahydrate, 125 ml of methanol and 125 ml of water were charged in the reaction vessel, and the mixture thus obtained was refluxed at 70° C. for 4.5 hours.

The resulting reaction mixture was allowed to cool, and methanol was removed under reduced pressure. 4.56 g of sodium hydroxide was added to the methanol-removed reaction mixture, and the resulting mixture was stirred at room temperature for 30 minutes. Thereafter, sodium bromide as a by-product was removed by hot filtration. The filtrate was concentrated under reduced pressure until precipitating crystals, and then allowed to stand. The crystals were filtered off and washed with ethanol and hexane. The crystals thus obtained were vacuum dried to obtain a sodium salt of S-(3-aminopropyl)thiosulfuric acid.

### Production of Compound B (sodium S-(6-aminohexyl)thiosulfate)

49.6 g (0.27 mol) of potassium phthalimide and 240 ml of dimethylformamide were charged in a 500 ml four-necked flask equipped with a stirrer, a thermometer and a condenser, and a mixture of 100 g (0.41 mol) of 1,6-dibromohexane and 100 ml of dimethylformamide was added dropwise to the mixture obtained above at room temperature. After completion of the dropwise addition, the mixture obtained was heated to 120° C., and refluxed for 4 hours. After completion of the reaction, a solvent was distilled away from the reaction mixture. Ethyl acetate and water were added to the reaction mixture to conduct liquid separation, and an organic layer was concentrated. Hexane and ethyl acetate were added to the residue obtained, and the mixture obtained was allowed to stand. As a result, crystals were precipitated. The crystals were filtered off, and then vacuum dried to obtain 56.5 g of N-(6-bromohexyl)phthalimide.

20 g (64.4 mmol) of N-(6-bromohexyl)phthalimide obtained above, 16.0 g (64.4 mmol) of sodium thiosulfate pentahydrate, 100 ml of methanol and 100 ml of water were charged in a 500 ml four-necked flask equipped with a stirrer, a thermometer and a condenser, and the mixture thus obtained was refluxed for 4 hours. After completion of the reaction, a solvent was distilled away from the reaction mixture. 100 ml of ethanol was added to the reaction mixture, and the resulting mixture was refluxed for 1 hour. About 5 g of sodium bromide as a by-product was removed by hot filtration. The filtrate was concentrated under reduced pressure until precipitating crystals, and then allowed to stand. The crystals were filtered off and washed with ethanol and hexane. The crystals obtained were vacuum dried to obtain 22.1 g of a sodium salt of 6-phthalimidehexylthiosulfuric acid.

A 500 ml four-necked flask equipped with a stirrer, a thermometer and a condenser was purged with nitrogen, and 20.0 g (54.7 mmol) of a sodium salt of 6-phthalimidehexylthiosulfuric acid and 200 ml of ethanol were charged in the flask. 4.25 g (84.8 mmol) of hydrazine monohydrate was added dropwise to the mixture obtained above. After completion of the dropwise addition, the mixture obtained was stirred at 70° C. for 5 hours, and ethanol was distilled away under reduced pressure. 100 ml of methanol was added to the residue obtained, followed by refluxing for 1 hour. Crystals were obtained by hot filtration, washed with methanol, and vacuum dried to obtain a sodium salt of 6-aminohexylthiosulfuric acid.

### Production of Tire Tread Member

According to the formulations shown in Tables 1 to 3, the respective components were mixed using Banbury mixer under the conditions shown in the mixing step (A) of the tables, a vulcanization accelerator and sulfur shown in the mixing step (B) of the tables were added and mixed, and vulcanization was conducted by heating at 150° C. for 30 minutes. Thus, tire tread members were obtained.

Temperature of the mixture in the step (A) was adjusted by PID control of rotor rotation speed of a mixer. For example, in the case of Example 1-1 in which reference temperature x is 150° C., PID control was conducted after the temperature in a mixing chamber reached 150° C., and a temperature range of from 145 to 155° C. was maintained for 25 seconds by changing the rotor rotation speed little by little (rise or fall).

Details of each material added as shown in Tables 1 to 3 are as follows.

Compound A: Sodium S-(3-aminopropyl)thiosulfate

Compound B: Sodium S-(6-aminohexyl)thiosulfate

NR: Natural rubber RSS#3

BR: BR150B, manufactured by Ube Industries, Ltd.

Carbon black A: SEAST 6, manufactured by Tokai Carbon Co., Ltd.

Carbon black B: SEAST 3, manufactured by Tokai Carbon Co., Ltd.

Oil: JOMO PROCESS P200, manufactured by Japan Energy Corporation

Silica: NIPSIL AQ, manufactured by Tosoh Silica Corporation

Silane coupling agent: Si69, manufactured by Evonik Degussa

Zinc oxide: Zinc flower, manufactured by Mitsui Mining & Smelting Co., Ltd.

Stearic acid: Bead stearic acid, manufactured by NOF Corporation

Age resister: ANTIGEN 6C, manufactured by Sumitomo Chemical Co., Ltd.

Wax: OZOACE 0355, manufactured by Nippon Seiro Co., Ltd.

Vulcanization accelerator: SANCELER CM, manufactured by Sanshin Chemical Industry Co., Ltd.

Sulfur: Powdered sulfur, manufactured by Tsurumi Chemical Industry Co., Ltd.

Abrasion resistance, tear strength and flex fatigue resistance of the rubber for a tread obtained above were evaluated by the following methods. The results obtained are shown in each table below.

Abrasion resistance: Measured according to JIS K6264. Slip ratio was 30%, applied load was 40N, and amount of sand dropped was 20 g/min. The results obtained are shown by an index in which the value of Comparative Example 1 is 100. The larger value shows greater abrasion resistance.

Tear strength: Measured according to JIS K6252. The results obtained are shown by an index in which the value of Comparative Example 1 is 100. The larger value shows greater tear strength.

Flex fatigue resistance: Flex crack growth test was conducted according to JIS K6260 (De Mattia type flex cracking test). The measurement was conducted under the condition of 23° C., and the number until crack growth reaches 2 mm was obtained. The results obtained are shown by an index in which the value of Comparative Example 1 is 100. The larger value shows greater fatigue resistance.

TABLE 1
(Formulation A for tread: Compound A)

| | | Comparative | Comparative | Comparative | Comparative | Comparative | Comparative | Comparative |
|---|---|---|---|---|---|---|---|---|
| | | Example 1-1 | Example 1-2 | Example 1-3 | Example 1-4 | Example 1-5 | Example 1-6 | Example 1-7 |
| Mixing step | Natural rubber | 80 | 80 | 80 | 80 | 80 | 80 | 80 |
| (A) | BR | 20 | 20 | 20 | 20 | 20 | 20 | 20 |
| | Carbon black A | 50 | 50 | 50 | 50 | 50 | 50 | 50 |
| | Oil | 2 | 2 | 2 | 2 | 2 | 2 | 2 |
| | Age resister | 2 | 2 | 2 | 2 | 2 | 2 | 2 |
| | Zinc oxide | 3 | 3 | 3 | 3 | 3 | 3 | 3 |
| | Stearic acid | 2 | 2 | 2 | 2 | 2 | 2 | 2 |
| | Compound A | | | 1 | 1 | 0.1 | 1 | 1 |
| | Discharge temperature (° C.) | 140 | 160 | 140 | 150 | 160 | 165 | 175 |
| | Reference temperature x (° C.) | — | 160 | — | 150 | 160 | — | 175 |
| | Mixing time at reference | — | 25 | — | 10 | 25 | — | 90 |
| | temperature x ± 5° C. (sec) | | | | | | | |
| | Mixing time at 145 to 170° C. | 0 | 32 | 0 | 10 | 33 | 12 | 18 |
| | (sec) | | | | | | | |
| Mixing step | Vulcanization accelerator | 1.5 | 1.5 | 1.5 | 1.5 | 1.5 | 1.5 | 1.5 |
| (B) | Sulfur | 1.5 | 1.5 | 1.5 | 1.5 | 1.5 | 1.5 | 1.5 |

| | | | | | | | |
|---|---|---|---|---|---|---|---|
| Abrasion resistance index | 100 | 103 | 101 | 102 | 102 | 101 | 95 |
| Tear strength index | 100 | 101 | 103 | 103 | 102 | 103 | 81 |
| Flex fatigue resistance index | 100 | 104 | 99 | 105 | 103 | 102 | 83 |

| | | Example | Example | Example | Example | Example | Example | Example | Example |
|---|---|---|---|---|---|---|---|---|---|
| | | 1-1 | 1-2 | 1-3 | 1-4 | 1-5 | 1-6 | 1-7 | 1-8 |
| Mixing step | Natural rubber | 80 | 80 | 80 | 80 | 80 | 80 | 80 | 80 |
| (A) | BR | 20 | 20 | 20 | 20 | 20 | 20 | 20 | 20 |
| | Carbon black A | 50 | 50 | 50 | 50 | 50 | 50 | 50 | 50 |
| | Oil | 2 | 2 | 2 | 2 | 2 | 2 | 2 | 2 |
| | Age resister | 2 | 2 | 2 | 2 | 2 | 2 | 2 | 2 |
| | Zinc oxide | 3 | 3 | 3 | 3 | 3 | 3 | 3 | 3 |
| | Stearic acid | 2 | 2 | 2 | 2 | 2 | 2 | 2 | 2 |
| | Compound A | 1 | 2.5 | 1 | 2.5 | 1 | 2.5 | 1 | 2.5 |
| | Discharge temperature (° C.) | 150 | 151 | 150 | 151 | 160 | 160 | 161 | 160 |
| | Reference temperature x (° C.) | 150 | 150 | 150 | 150 | 160 | 160 | 160 | 160 |
| | Mixing time at reference | 25 | 25 | 55 | 55 | 25 | 25 | 55 | 55 |
| | temperature x ± 5° C. (sec) | | | | | | | | |
| | Mixing time at 145 to 170° C. (sec) | 25 | 25 | 55 | 55 | 33 | 32 | 63 | 61 |
| Mixing step | Vulcanization accelerator | 1.5 | 1.5 | 1.5 | 1.5 | 1.5 | 1.5 | 1.5 | 1.5 |
| (B) | Sulfur | 1.5 | 1.5 | 1.5 | 1.5 | 1.5 | 1.5 | 1.5 | 1.5 |

| | | | | | | | | |
|---|---|---|---|---|---|---|---|---|
| Abrasion resistance index | 106 | 105 | 107 | 108 | 110 | 109 | 111 | 110 |
| Tear strength index | 108 | 111 | 111 | 112 | 111 | 108 | 110 | 114 |
| Flex fatigue resistance index | 110 | 113 | 115 | 118 | 118 | 116 | 116 | 120 |

TABLE 2
(Formulation A for tread: Compound B)

| | | Comparative | Comparative | Comparative | Comparative | Comparative | Comparative | Comparative |
|---|---|---|---|---|---|---|---|---|
| | | Example 2-1 | Example 2-2 | Example 2-3 | Example 2-4 | Example 2-5 | Example 2-6 | Example 2-7 |
| Mixing step | Natural rubber | 80 | 80 | 80 | 80 | 80 | 80 | 80 |
| (A) | BR | 20 | 20 | 20 | 20 | 20 | 20 | 20 |
| | Carbon black A | 50 | 50 | 50 | 50 | 50 | 50 | 50 |
| | Oil | 2 | 2 | 2 | 2 | 2 | 2 | 2 |
| | Age resister | 2 | 2 | 2 | 2 | 2 | 2 | 2 |
| | Zinc oxide | 3 | 3 | 3 | 3 | 3 | 3 | 3 |
| | Stearic acid | 2 | 2 | 2 | 2 | 2 | 2 | 2 |
| | Compound B | | | 1 | 1 | 0.1 | 1 | 1 |
| | Discharge temperature (° C.) | 140 | 160 | 140 | 151 | 160 | 165 | 175 |
| | Reference temperature x (° C.) | — | 160 | — | 150 | 160 | — | 175 |
| | Mixing time at reference | — | 25 | — | 10 | 25 | — | 90 |
| | temperature x ± 5° C. (sec) | | | | | | | |
| | Mixing time at 145 to 170° C. | 0 | 32 | 0 | 10 | 32 | 13 | 18 |
| | (sec) | | | | | | | |
| Mixing step | Vulcanization accelerator | 1.5 | 1.5 | 1.5 | 1.5 | 1.5 | 1.5 | 1.5 |
| (B) | Sulfur | 1.5 | 1.5 | 1.5 | 1.5 | 1.5 | 1.5 | 1.5 |

| | | | | | | | |
|---|---|---|---|---|---|---|---|
| Abrasion resistance index | 100 | 103 | 102 | 103 | 101 | 102 | 94 |
| Tear strength index | 100 | 101 | 102 | 103 | 102 | 103 | 79 |
| Flex fatigue resistance index | 100 | 104 | 99 | 104 | 102 | 104 | 80 |

| | | Example | Example | Example | Example | Example | Example | Example | Example |
|---|---|---|---|---|---|---|---|---|---|
| | | 2-1 | 2-2 | 2-3 | 2-4 | 2-5 | 2-6 | 2-7 | 2-8 |
| Mixing step | Natural rubber | 80 | 80 | 80 | 80 | 80 | 80 | 80 | 80 |
| (A) | BR | 20 | 20 | 20 | 20 | 20 | 20 | 20 | 20 |
| | Carbon black A | 50 | 50 | 50 | 50 | 50 | 50 | 50 | 50 |
| | Oil | 2 | 2 | 2 | 2 | 2 | 2 | 2 | 2 |
| | Age resister | 2 | 2 | 2 | 2 | 2 | 2 | 2 | 2 |
| | Zinc oxide | 3 | 3 | 3 | 3 | 3 | 3 | 3 | 3 |
| | Stearic acid | 2 | 2 | 2 | 2 | 2 | 2 | 2 | 2 |
| | Compound B | 1 | 2.5 | 1 | 2.5 | 1 | 2.5 | 1 | 2.5 |
| | Discharge temperature (° C.) | 151 | 151 | 151 | 152 | 161 | 160 | 161 | 162 |
| | Reference temperature x (° C.) | 150 | 150 | 150 | 150 | 160 | 160 | 160 | 160 |
| | Mixing time at reference | 25 | 25 | 55 | 55 | 25 | 25 | 55 | 55 |
| | temperature x ± 5° C. (sec) | | | | | | | | |
| | Mixing time at 145 to 170° C. (sec) | 25 | 25 | 55 | 55 | 35 | 35 | 67 | 66 |
| Mixing step | Vulcanization accelerator | 1.5 | 1.5 | 1.5 | 1.5 | 1.5 | 1.5 | 1.5 | 1.5 |
| (B) | Sulfur | 1.5 | 1.5 | 1.5 | 1.5 | 1.5 | 1.5 | 1.5 | 1.5 |

| | | | | | | | | |
|---|---|---|---|---|---|---|---|---|
| Abrasion resistance index | 105 | 106 | 106 | 108 | 109 | 111 | 109 | 110 |
| Tear strength index | 107 | 110 | 109 | 111 | 113 | 110 | 109 | 111 |
| Flex fatigue resistance index | 112 | 113 | 114 | 115 | 117 | 117 | 115 | 116 |

TABLE 3
(Formulation B for tread)

| | | Comparative | Comparative | Comparative | Comparative | Comparative | Comparative | Comparative |
|---|---|---|---|---|---|---|---|---|
| | | Example 3-1 | Example 3-2 | Example 3-3 | Example 3-4 | Example 3-5 | Example 3-6 | Example 3-7 |
| Mixing step | Natural rubber | 100 | 100 | 100 | 100 | 100 | 100 | 100 |
| (A) | Carbon black A | 25 | 25 | 25 | 25 | 25 | 25 | 25 |
| | Silica | 10 | 10 | 10 | 10 | 10 | 10 | 10 |
| | Silane coupling agent | 1 | 1 | 1 | 1 | 1 | 1 | 1 |
| | Oil | 2 | 2 | 2 | 2 | 2 | 2 | 2 |
| | Age resister | 2 | 2 | 2 | 2 | 2 | 2 | 2 |
| | Zinc oxide | 3 | 3 | 3 | 3 | 3 | 3 | 3 |
| | Stearic acid | 2 | 2 | 2 | 2 | 2 | 2 | 2 |
| | Compound A | | | 1 | 1 | 0.1 | 1 | 1 |
| | Discharge temperature (° C.) | 140 | 160 | 140 | 151 | 160 | 165 | 175 |
| | Reference temperature x (° C.) | — | 160 | — | 150 | 160 | — | 175 |
| | Mixing time at reference | — | 25 | — | 10 | 25 | — | 90 |
| | temperature x ± 5° C. (sec) | | | | | | | |
| | Mixing time at 145 to 170° C. | 0 | 36 | 0 | 10 | 33 | 13 | 18 |
| | (sec) | | | | | | | |
| Mixing step | Vulcanization accelerator | 1.4 | 1.4 | 1.4 | 1.4 | 1.4 | 1.4 | 1.4 |
| (B) | Sulfur | 1.6 | 1.6 | 1.6 | 1.6 | 1.6 | 1.6 | 1.6 |

| | | | | | | | |
|---|---|---|---|---|---|---|---|
| Abrasion resistance index | 100 | 103 | 102 | 103 | 101 | 102 | 94 |
| Tear strength index | 100 | 100 | 101 | 104 | 99 | 103 | 76 |
| Flex fatigue resistance index | 100 | 102 | 104 | 103 | 99 | 104 | 77 |

| | | Example | Example | Example | Example | Example | Example | Example | Example |
|---|---|---|---|---|---|---|---|---|---|
| | | 3-1 | 3-2 | 3-3 | 3-4 | 3-5 | 3-6 | 3-7 | 3-8 |
| Mixing step | Natural rubber | 100 | 100 | 100 | 100 | 100 | 100 | 100 | 100 |
| (A) | Carbon black A | 25 | 25 | 25 | 25 | 25 | 25 | 25 | 25 |
| | Silica | 10 | 10 | 10 | 10 | 10 | 10 | 10 | 10 |
| | Silane coupling | 1 | 1 | 1 | 1 | 1 | 1 | 1 | 1 |
| | agent | | | | | | | | |
| | Oil | 2 | 2 | 2 | 2 | 2 | 2 | 2 | 2 |
| | Age resister | 2 | 2 | 2 | 2 | 2 | 2 | 2 | 2 |
| | Zinc oxide | 3 | 3 | 3 | 3 | 3 | 3 | 3 | 3 |
| | Stearic acid | 2 | 2 | 2 | 2 | 2 | 2 | 2 | 2 |
| | Compound A | 1 | 2.5 | 1 | 2.5 | 1 | 2.5 | 1 | 2.5 |
| | Discharge temperature (° C.) | 152 | 150 | 150 | 151 | 160 | 162 | 161 | 161 |
| | Reference temperature x (° C.) | 150 | 150 | 150 | 150 | 160 | 160 | 160 | 160 |
| | Mixing time at reference | 25 | 25 | 55 | 55 | 25 | 25 | 55 | 55 |
| | temperature x ± 5° C. (sec) | | | | | | | | |
| | Mixing time at 145 to 170° C. (sec) | 25 | 25 | 55 | 55 | 37 | 36 | 66 | 67 |
| Mixing step | Vulcanization accelerator | 1.4 | 1.4 | 1.4 | 1.4 | 1.4 | 1.4 | 1.4 | 1.4 |
| (B) | Sulfur | 1.6 | 1.6 | 1.6 | 1.6 | 1.6 | 1.6 | 1.6 | 1.6 |

| | | | | | | | | |
|---|---|---|---|---|---|---|---|---|
| Abrasion resistance index | 107 | 109 | 106 | 107 | 110 | 109 | 110 | 109 |
| Tear strength index | 108 | 110 | 113 | 111 | 111 | 110 | 109 | 109 |
| Flex fatigue resistance index | 109 | 114 | 112 | 113 | 116 | 118 | 117 | 115 |

It is seen from the results shown in Tables 1 to 3 that the rubber member of each example in which a predetermined amount of the thiosulfuric acid compound A or B was added and the temperature of the mixture during mixing was maintained at from 145 to 170° C. for 20 seconds or more in the step (A) is improved all in abrasion resistance, tear strength and flex fatigue resistance, as compared with the rubber members of the comparative examples that do not satisfy any one of those requirements.

### Production of Tire Sidewall Member

A sidewall member was produced in the same manner as in the production of the tread member, except for using components and mixing conditions shown in Table 4. The details of each material added shown in Table 4 are the same as above. As for the obtained sidewall member, tear strength and flex fatigue resistance were evaluated by the same methods as described above. The results obtained are shown in Table 4 below.

TABLE 4
(Formulation for sidewall)

| | | Comparative | Comparative | Comparative | Comparative | Comparative | Comparative | Comparative | Comparative |
|---|---|---|---|---|---|---|---|---|---|
| | | Example 4-1 | Example 4-2 | Example 4-3 | Example 4-4 | Example 4-5 | Example 4-6 | Example 4-7 | Example 4-8 |
| Mixing | Natural rubber | 50 | 50 | 50 | 50 | 50 | 50 | 50 | 50 |
| step | BR | 50 | 50 | 50 | 50 | 50 | 50 | 50 | 50 |
| (A) | Carbon black B | 40 | 40 | 40 | 40 | 40 | 40 | 40 | 30 |
| | Silica | | | | | | | | 10 |
| | Silane coupling agent | | | | | | | | 1 |
| | Oil | 8 | 8 | 8 | 8 | 8 | 8 | 8 | 8 |
| | Zinc oxide | 2 | 2 | 2 | 2 | 2 | 2 | 2 | 2 |
| | Stearic acid | 2 | 2 | 2 | 2 | 2 | 2 | 2 | 2 |
| | Age resister | 5 | 5 | 5 | 5 | 5 | 5 | 5 | 5 |
| | Wax | 1 | 1 | 1 | 1 | 1 | 1 | 1 | 1 |
| | Compound A | | | 1 | 1 | 0.1 | 1 | 1 | 1 |
| | Discharge temperature | 140 | 160 | 140 | 150 | 160 | 165 | 175 | 151 |
| | (° C.) | | | | | | | | |
| | Reference temperature x | — | 160 | — | 150 | 160 | — | 175 | 150 |
| | (° C.) | | | | | | | | |
| | Mixing time at reference | — | 25 | — | 10 | 25 | — | 90 | 5 |
| | temperature x ± 5° C. | | | | | | | | |
| | (sec) | | | | | | | | |
| | Mixing time at | 0 | 36 | 0 | 10 | 33 | 15 | 18 | 17 |
| | 145 to 170° C. (sec) | | | | | | | | |
| Mixing | Vulcanization accelerator | 1 | 1 | 1 | 1 | 1 | 1 | 1 | 1 |
| step | Sulfur | 2 | 2 | 2 | 2 | 2 | 2 | 2 | 2 |
| (B) | | | | | | | | | |

| | | | | | | | | |
|---|---|---|---|---|---|---|---|---|
| Tear strength index | 100 | 101 | 103 | 103 | 102 | 104 | 87 | 95 |
| Flex fatigue resistance index | 100 | 103 | 101 | 103 | 104 | 103 | 85 | 102 |

| | | Example | Example | Example | Example | Example | Example | Example | Example | Example |
|---|---|---|---|---|---|---|---|---|---|---|
| | | 4-1 | 4-2 | 4-3 | 4-4 | 4-5 | 4-6 | 4-7 | 4-8 | 4-9 |
| Mixing | Natural rubber | 50 | 50 | 50 | 50 | 50 | 50 | 50 | 50 | 50 |
| step | BR | 50 | 50 | 50 | 50 | 50 | 50 | 50 | 50 | 50 |
| (A) | Carbon black B | 40 | 40 | 40 | 40 | 40 | 40 | 40 | 40 | 30 |
| | Silica | | | | | | | | | 10 |
| | Silane coupling agent | | | | | | | | | 1 |
| | Oil | 8 | 8 | 8 | 8 | 8 | 8 | 8 | 8 | 8 |
| | Zinc oxide | 2 | 2 | 2 | 2 | 2 | 2 | 2 | 2 | 2 |
| | Stearic acid | 2 | 2 | 2 | 2 | 2 | 2 | 2 | 2 | 2 |
| | Age resister | 5 | 5 | 5 | 5 | 5 | 5 | 5 | 5 | 5 |
| | Wax | 1 | 1 | 1 | 1 | 1 | 1 | 1 | 1 | 1 |
| | Compound A | 1 | 2.5 | 1 | 2.5 | 1 | 2.5 | 1 | 2.5 | 1 |
| | Discharge temperature (° C.) | 150 | 151 | 152 | 151 | 160 | 160 | 162 | 160 | 161 |
| | Reference temperature x (° C.) | 150 | 150 | 150 | 150 | 160 | 160 | 160 | 160 | 160 |
| | Mixing time at reference | 25 | 25 | 55 | 55 | 25 | 25 | 55 | 55 | 55 |
| | temperature x ± 5° C. (sec) | | | | | | | | | |
| | Mixing time at 145 to 170° C. | 25 | 25 | 55 | 55 | 37 | 36 | 66 | 65 | 66 |
| | (sec) | | | | | | | | | |
| Mixing | Vulcanization accelerator | 1 | 1 | 1 | 1 | 1 | 1 | 1 | 1 | 1 |
| step | Sulfur | 2 | 2 | 2 | 2 | 2 | 2 | 2 | 2 | 2 |
| (B) | | | | | | | | | | |

| | | | | | | | | | |
|---|---|---|---|---|---|---|---|---|---|
| Tear strength index | 109 | 112 | 109 | 110 | 114 | 110 | 112 | 114 | 109 |
| Flex fatigue resistance index | 110 | 113 | 112 | 110 | 115 | 117 | 117 | 119 | 120 |

It is seen from the results shown in Table 4 that the rubber member of each example in which a predetermined amount of the thiosulfuric acid compound A was added and the temperature of the mixture during mixing was maintained at from 145 to 170° C. for 20 seconds or more in the step (A) is improved both in tear strength and flex fatigue resistance, as compared with the rubber members of the comparative examples that do not satisfy any one of those requirements.

The tire member obtained by the method for manufacturing a tire member according to the present invention can be used in various tires such as radial tires for passenger cars, and tires for heavy load of tracks, buses and the like.

What is claimed is:

1. A method for manufacturing a tire member, comprising a step (A) for mixing at least a rubber component, a filler and a thiosulfuric acid compound containing an amino group, and a step (B) for mixing the mixture obtained by the step (A), a sulfur component, and a vulcanization accelerator, wherein
the thiosulfuric acid compound containing an amino group is added in an amount of 0.2 parts by mass or more to 100 parts by mass of the rubber component in the step (A), and
a temperature of the mixture during mixing is maintained in a range of from 145 to 170° C. for 20 seconds or more in the step (A).

2. The method for manufacturing a tire member according to claim 1, wherein the temperature of the mixture during mixing is maintained in a range of x±5° C. (x=150 to 165° C.) for 20 seconds or more in the step (A).

3. The method for manufacturing a tire member according to claim 1, wherein the thiosulfuric acid compound containing an amino group is at least one selected from the group consisting of thiosulfuric acid compounds represented by any one of the following formulae (1) to (3) and their salts: 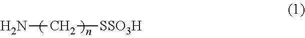
wherein n is an integer of from 2 to 9; 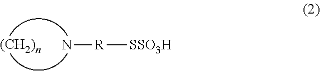
wherein R represents an alkanediyl group having from 3 to 12 carbon atoms, and n is an integer of from 2 to 5; and 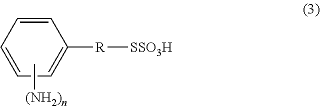
wherein R represents an alkanediyl group having from 1 to 6 carbon atoms, and n is an integer of from 1 to 2.

4. The method for manufacturing a tire member according to claim 1, wherein the mixing in the step (A) is conducted with a mixing apparatus equipped with a stirring rotor, a jacket through which a heating/cooling medium flows, and a pressure ram, and at least one of a rotation speed of the stirring rotor of the mixing apparatus, a temperature of the heating/cooling medium, and the ram pressure is controlled to maintain the temperature of the mixture within the temperature range.

5. The method for manufacturing a tire member according to claim 1, comprising manufacturing a tread member or a sidewall member of a tire.

6. A tire member obtained by the manufacturing method according to claim 1.

7. A tire having the tire member according to claim 6.
